(19) United States
(12) Patent Application Publication
(10) Pub. No.: US 2013/0164096 A1
(43) Pub. Date: Jun. 27, 2013

(54) FASTENING DEVICE ON A BUILDING

(71) Applicants: Rene Dutler, Eichberg (CH); Jaroslav Stok, Praha 10 (CZ)

(72) Inventors: Rene Dutler, Eichberg (CH); Jaroslav Stok, Praha 10 (CZ)

(73) Assignee: SFS INTEC HOLDING AG, Heerbrugg (CH)

(21) Appl. No.: 13/821,035

(22) PCT Filed: Aug. 22, 2011
(86) PCT No.: PCT/EP11/64349

§ 371 Date: Mar. 6, 2013

(30) Foreign Application Priority Data
Sep. 28, 2010 (DE) 102010037831.3

(51) Int. Cl. F16B 25/10; F16B 33/00; F16B 43/00; F16B 35/00

(52) U.S. Cl. CPC F16B 25/10; F16B 35/00; F16B 33/00; F16B 43/001
USPC 411/366.1; 411/378; 411/386; 411/387.1; 411/371.1

(57) ABSTRACT

A device for fastening equipment parts such as photovoltaic panels on a sandwich or single-shell building envelope using a plurality of fastening elements (20, 20′) in the form of bolts, which can be supported at least by a connection part (30, 30′) and on a load-bearing part (12) of the building or the building envelope. If an outer shell (14) is present, the fastening elements (20, 20′) can be guided through the outer shell (14) and supported on the load-bearing part (12) and/or the outer shell (14). Each fastening element (20, 20′) can be positively engaged with the connection part (30, 30′) and/or, if present, with the outer shell (14) so as in each case to support the connection part (30, 30′) on the load-bearing part (12) and, if present, on the outer shell (14). A device for fastening equipment parts such as photovoltaic panels on a sandwich or single-shell building envelope using a plurality of fastening elements (20, 20′) in the form of bolts, which can be supported at least by a connection part (30, 30′) and on a load-bearing part (12) of the building or the building envelope. If an outer shell (14) is present, the fastening elements (20, 20′) can be guided through the outer shell (14) and supported on the load-bearing part (12) and/or the outer shell (14). Each fastening element (20, 20′) can be positively engaged with the connection part (30, 30′) and/or, if present, with the outer shell (14) so as in each case to support the connection part (30, 30′) on the load-bearing part (12) and, if present, on the outer shell (14).

### BACKGROUND

The invention relates to a device for fastening equipment parts such as photovoltaic panels to a sandwich or single-shell building envelope with the aid of a plurality of bolt-shaped fastening elements which may be supported, at least by a connecting part, on a load-bearing part of the building or building envelope.

A device similar to the above-mentioned device is known, in connection with a furring structure for double-shell roof systems having a support structure, from EP 0685612 A1. In this case, the support structure is the furring structure of a building envelope which includes a thermal insulation layer arranged on the support structure and spacer profiles, wherein the latter are connected to the support structure and have, on the side facing away from the support structure, a connecting part having a planar fastening surface for fastening a cladding. The connecting part provided with the fastening surface rests on the surface of the thermal insulation layer facing away from the support structure. The connecting part is formed by spacer profiles made from an elongate U-shaped profile whereof the base of the U forms the fastening surface. The base of the U of the U-shaped profile and the support structure are connected to one another by screws arranged spaced from one another. The fact that the connecting part is supported on the insulation layer must be regarded as disadvantageous because as a result it is not possible to maintain a fixed spacing between the connecting part and the support structure. Thus, equipment parts such as photovoltaic panels which might be fastened to the connecting part 20 would not have a defined position on the building envelope.

A similar prior art in which the connecting part is supported on the insulation layer is also disclosed by EP 0854252 A2 and EP 0969160 A2.

A device of the type mentioned at the outset is known from DE 20 2009 015 787 U1. In this known device, a plate is not supported but rests on an insulation material. Fastening elements in the form of cavity attachments exert pressure on the plate from above in order to keep it on the insulation material and prevent a mounting pin from tilting. The mounting pin is supported by its lower end on a trapezoidal metal sheet, that is to say on the roof surface, and is screwed at its upper end directly to a support frame of a solar panel system. By means of a nut, the mounting pin presses onto the plate, similarly only from above, so does not provide any supporting function for it either. Because the fastening elements and the mounting pin are guided through the plate, a form-fitting connection is produced, though this acts only radially and not axially, since it has no effect as regards supporting the weight of the support frame on the roof surface. This structure is intended to prevent the plate from rocking. Although this goal is indeed achieved, it is dependent on the strength of the insulation material, which must in itself be able to prevent the plate from rocking.

DE 10 2009 033 416 B3 discloses a fastening system in which an attachment part, which may be a support frame for a solar panel system, is supported on the roof construction purely by a single fastening element, which corresponds to the mounting pin in the document cited above. In fact, the fastening system according to this cited document differs from the mounting device according to the document cited previously only in that the fastening element is screwed into the trapezoidal metal sheet instead of merely being supported thereon, as in the previously cited document. Below the attachment part there are an adjusting member and two pressure plates which clearly serve only to clamp a roofing film, presumably for reasons of sealing. If the fastening element were to wobble during use, for example as a result of wind acting on the solar panel system, its wobbling movement would be damped by the bearing surface of the roofing film, a disadvantage also displayed by the mounting device according to the previously cited document.

### SUMMARY

It is the object of the invention to construct a device of the type mentioned at the outset such that an outer shell or a connecting part maintains a fixed spacing from a load-bearing part of the building or building envelope.

This object is achieved according to the invention in that, if there is an outer shell, the fastening elements may be guided through the outer shell and supported on the load-bearing part and/or the outer shell, and in that each fastening element may be brought form-fittingly into engagement with the connecting part and/or the outer shell if there is one, in each case in order that the connecting part is supported on the load-bearing part and on the outer shell if there is one. The form-fitting engagement between the fastening element on the one hand and the outer shell and/or the connecting part on the other ensures that the connecting part is supported at least on the load-bearing part, with the result that there is no change in the spacing from the load-bearing part over time. Equipment parts, including those of relatively great weight, such as photovoltaic panels and the frame constructions associated therewith, may thus be fastened using the device according to the invention, permanently and in particular such that they are fixed in position, that is to say with no risk that they rock or wobble on a building envelope.

Advantageous embodiments of the device according to the invention form the subjects of the respective dependent claims.

In an embodiment of the device according to the invention, the connecting part is a panel which has, for at least each fastening element, an opening or an opening in preparation for when it is made. In this way, it is more easily possible to make individual fastening points in a defined manner than with a spacer profile taking the form of an elongate U-shaped profile, as in the prior art considered above.

In a further embodiment of the device according to the invention, each fastening element is a self-drilling and self-tapping or self-forming threaded screw having a drilling part for engaging in the load-bearing part. The device may thus be mounted on the building envelope quickly and reliably.

In a further embodiment of the device according to the invention, each fastening element is provided, in a portion away from the drilling part, with a support thread. The form-fitting engagement between the fastening element and the outer shell and/or the connecting part can thus be made in a simple manner by setting the fastening element so deeply in the load-bearing part that the support thread comes into form-fitting engagement with the outer shell or comes to lie directly below the outer shell, in order to support the latter on the support thread in relation to the load-bearing part.

In a further embodiment of the device according to the invention, a sleeve-shaped connecting element which is provided with a connecting thread is inserted into one of the openings. The connecting thread may be a female or a male thread that serves to fasten equipment parts. In this case, the connecting part is fastened to the building envelope by further fastening elements which may be brought form-fittingly into engagement with the connecting part, in order in this way to support the connecting part on the load-bearing part.

In a further embodiment of the device according to the invention, the connecting element is provided with a plate for fixing in the connecting part. Here, in a further embodiment of the device according to the invention, the connecting element may be arranged in a central region of the connecting part.

In a further embodiment of the device according to the invention, the connecting element is arranged in a central region of the connecting part. This construction ensures uniform transmission of force from the connecting part to the part (for example the outer shell) that bears the connecting part.

In a further embodiment of the device according to the invention, at least one of the fastening elements may be fixed form-fittingly in the connecting element. Both the constructions mentioned above are suitable for this. It is possible to dispense with form-fittingly fixing at least one fastening element for support on the load-bearing part if the connecting part is supported directly on an outer shell which is supported on the load-bearing part, for example the furring structure of the building envelope, without an intermediate insulation layer. In this case, it is sufficient to fasten the connecting part simply to the outer shell using a plurality of fastening elements.

In a further embodiment of the device according to the invention, at least one force transmission element may be mounted on the connecting element, as an intermediate member between the device and one of the equipment parts. This construction facilitates the alignment of equipment parts with one or each individual fastening point, for example on the building envelope.

In a further embodiment of the device according to the invention, the connecting part is angled in an edge region in the direction away from the load-bearing part. Fastening elements that are tightened in the load-bearing part through openings in the edge region produce a more stable position of the connecting part on the outer shell.

In a further embodiment of the device according to the invention, the or each opening in the unmounted connecting part takes the form of a blind hole or, in preparation for making the or each opening, the position thereof is marked out in advance on the connecting part as a pattern of bores. This construction enables the or each opening to be made in the connecting part only during mounting.

In a further embodiment of the device according to the invention, a sealing disk may be inserted between a head of the or each fastening element and the connecting part. This ensures that a building envelope remains sealed during use of the device according to the invention.

### BRIEF DESCRIPTION OF THE DRAWINGS

Exemplary embodiments of the invention will be described in more detail below with reference to the drawings, in which:

FIG. 1 shows, in a sectional view, a first embodiment of a device according to the invention mounted on a sandwich building envelope,

FIG. 2 shows, in the same view as in FIG. 1, a somewhat modified first embodiment of the device according to the invention,

FIG. 3 shows a plan view of a connecting part of the device according to FIG. 1,

FIG. 4 shows the connecting part in a sectional view along the line IV-IV in FIG. 3,

FIG. 5 shows a sleeve-shaped connecting element of the connecting part according to FIG. 3, namely a longitudinal side view in FIG. 5a, a bottom view in FIG. 5b and a longitudinal sectional view in FIG. 5c,

FIG. 6 shows a plan view of a connecting part of the device according to FIG. 2, wherein a corner of the connecting part is additionally shown in section as a detail, so that the angled construction thereof is visible,

FIG. 7 shows a connecting element of the connecting part according to FIG. 6, namely a longitudinal side view in FIG. 7a, a bottom view in FIG. 7b and a longitudinal sectional view in FIG. 7c,

FIG. 8 shows a second embodiment of the connecting part of the device according to the invention,

FIG. 9 shows, in a front view and partly in section, the connecting part according to FIG. 8 when it is used on a corrugated outer shell,

FIG. 10 shows the arrangement according to FIG. 9 in a partly sectional view turned through 90°,

FIG. 11 shows the arrangement according to FIGS. 9 and 10 in a perspective view, and

FIG. 12 shows the use of the device according to the invention on a single-shell building envelope, in the same view as in FIG. 11.

### DETAILED DESCRIPTION OF THE PREFERRED EMBODIMENTS

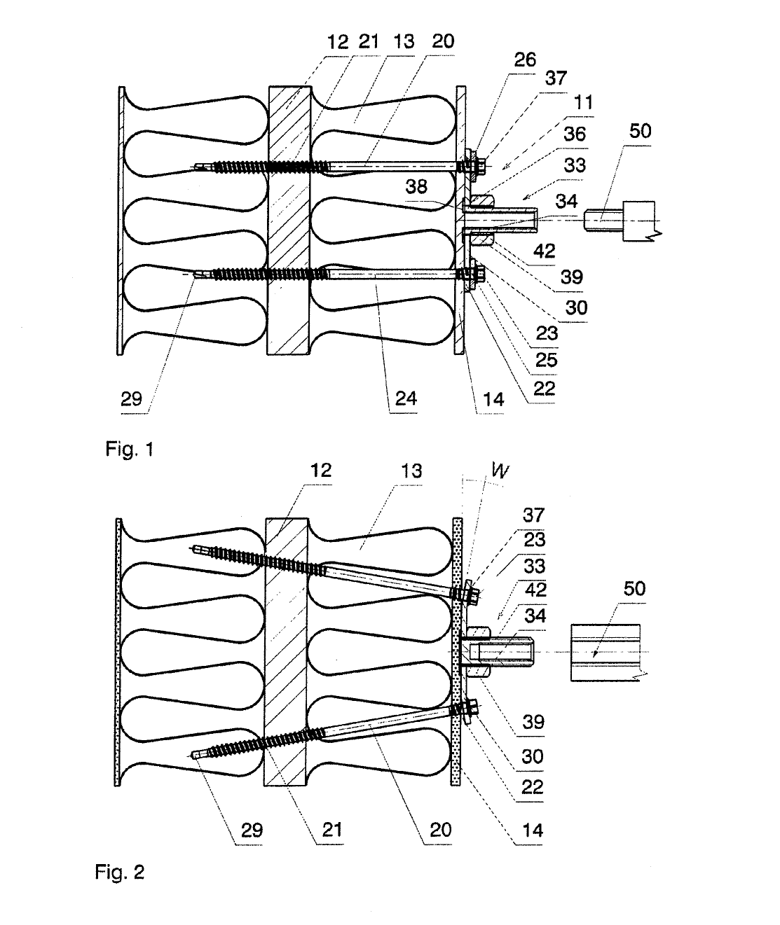

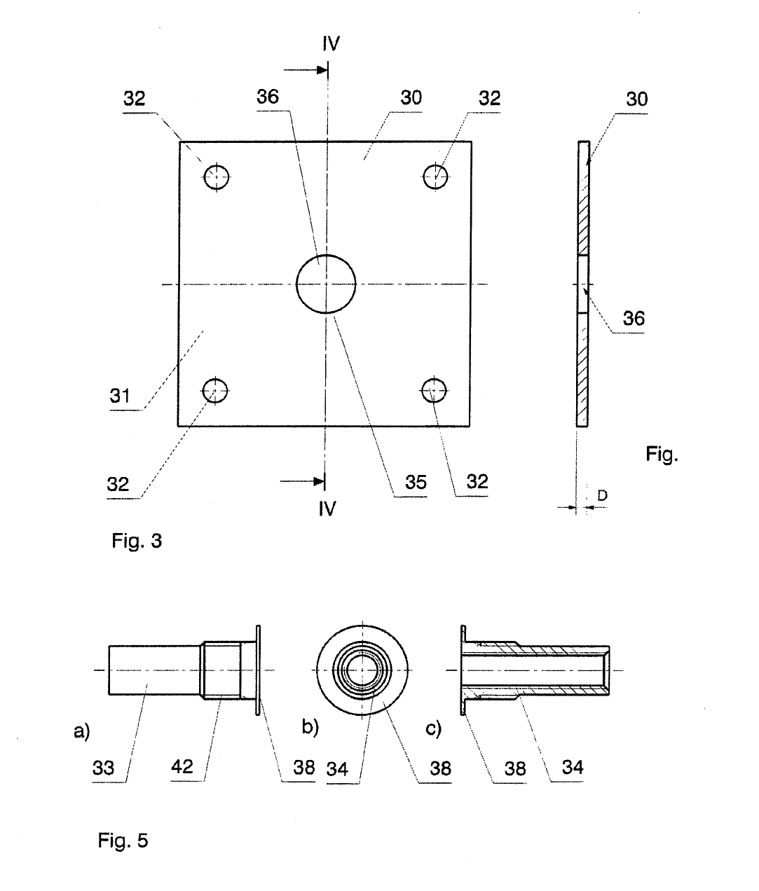

FIG. 1 shows, in a sectional view, the use of a first embodiment of a fastening device according to the invention, designated 11 overall, for equipment parts (not illustrated) such as photovoltaic panels on a multiple-shell building envelope. The latter includes a furring structure, which is presented as a load-bearing part 12. On the load-bearing part 12 there is a thermal insulation layer 13 which is covered by an outer shell 14. The fastening device 11 includes a connecting part 30 which takes the form of a square panel, shown in plan view in FIG. 3. The connecting part 30 has in the edge region of the periphery four openings 32, which are each in the form of a through bore, and in a central region 35 an opening 36, which is also in the form of a through bore. The connecting part 30 is of a thickness D (FIG. 4). According to the illustration in FIG. 1, a sleeve-shaped connecting element 33 is inserted into the opening 36 and is provided on the inside with a connecting thread 34. According to the illustration in FIGS. 5a-5c, the connecting element 33 is provided with a plate 38 for fixing in the connecting element 33. The plate 38 may be countersunk in a circular depression in the outer shell 14, as is visible in FIG. 1. The connecting element 33 is fixed in the opening 36 with the aid of a locking nut 39.

In the above-mentioned exemplary embodiment and in the exemplary embodiments described below, each bolt-shaped fastening element is a self-drilling and self-tapping or self-forming screw having an anchoring thread 21 and a drilling part 29 for engagement in the load-bearing part 12.

FIG. 2 shows a somewhat modified embodiment of the connecting part 30, which is again a square panel but is angled at all four corners in an edge region 31 in the direction away from the load-bearing part 12, as is visible in FIGS. 2 and 6. Top right in FIG. 6, a corner which is angled by an angle W is illustrated as a detail. The construction of the connecting part 30 according to FIG. 6 has the effect that when the fastening device 10 is mounted the fastening elements 20 inserted in the openings 32 are angled at the same angle W in relation to the outer shell 14, and accordingly in relation to the load-bearing part 12. The sleeve-shaped connecting element 33 which is inserted into the connecting part 30 according to FIG. 2 may be the same connecting element 33 as in the embodiment according to FIG. 1. In both cases, the connecting element 33 is fixed in the connecting part 30 with the aid of the above-mentioned locking nut 39, which is screwed onto a male thread 42 on the connecting element 33.

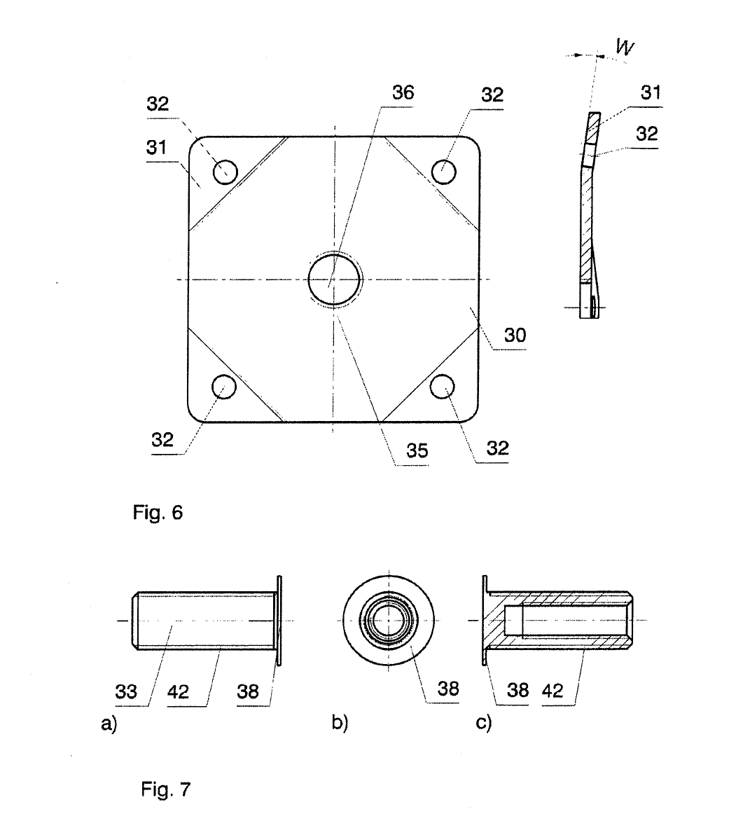

The connecting element 33 according to FIGS. 2 and 7a-7c has substantially the same construction as the connecting element 33 in FIGS. 1 and 5a-5c-5c, making any further description unnecessary.

According to the illustration in FIGS. 1 and 2, the fastening elements 20 inserted in the edge region 31 of the connecting part 30 are each provided with a support thread 22 below a head 23. The support thread 22 is self-tapping and, in FIGS. 1 and 2, is in each case in threaded engagement with the outer shell 14. The support thread 22 could instead be arranged closer to the anchoring thread 21, with the result that after being screwed through the outer shell 14, the anchoring thread 21 is supported on its left side, in each case as seen in the illustration in FIGS. 1 and 2.

A force transmission element 50 may be screwed into the connecting element 33, as in FIG. 1, or screwed onto the connecting element 33, as in FIG. 2.

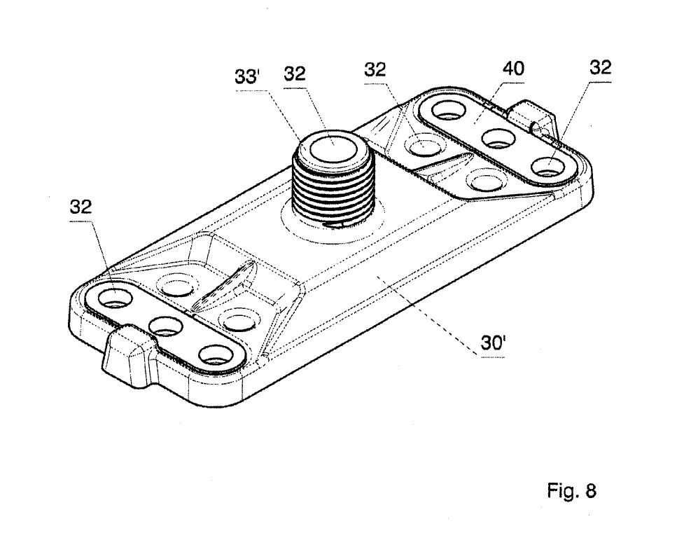

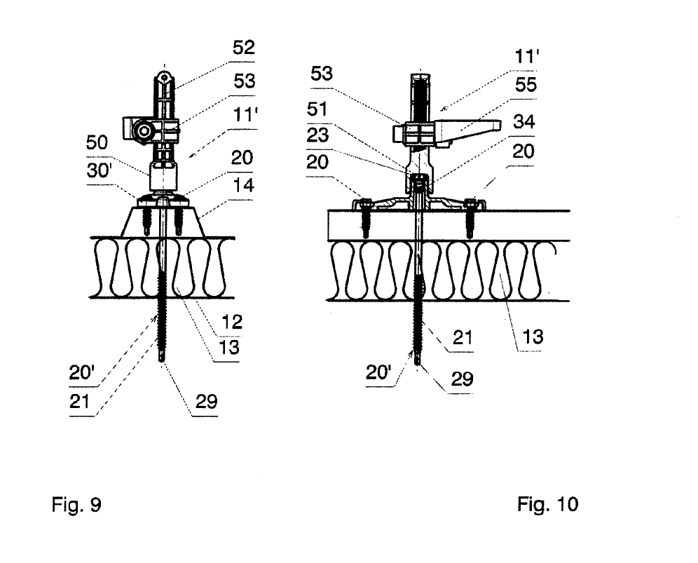

FIG. 8 shows, in a perspective illustration, a connecting part 30′ of a second embodiment of a fastening device 11′ according to the invention. A sleeve-shaped connecting element 33′ is integrally formed on the connecting part 30′. The connecting part 30′ is a rectangular panel which has in the edge regions, in the region of its two short sides, in each case five openings 32 for fastening elements 20. The three openings 32 respectively on the outside are made in a panel inset part 40. The panel inset part 40 may in each case be made of metal, whereas the connecting part 30′ may be made of glass-reinforced plastic material. The openings 32 may each take the form of a blind hole in the unmounted connecting part 30′, or the or each opening 32 may be prepared for when it is made, for example by marking out the position of the or each opening 32 in advance on the connecting part 30′ as a pattern of bores (not illustrated).

In the case of the fastening device 11′ according to FIGS. 8-11, the bolt-shaped fastening element 20′ is a self-drilling and self-tapping or self-forming screw having the anchoring thread 21 and the drilling part 29 for engagement in the load-bearing part 12. Once the screw is tightened, it extends through the opening 32 and, according to the partly sectional view in FIG. 10, is fixed with its head 23 on the upper edge of the connecting element 33′. According to FIG. 10, the force transmission element 50 is screwed onto the connecting thread 34 of the connecting element 33′, in this case forming an integral part of a post 52. The root of a threaded bore in the force transmission element 50 forms a stop 51 by means of which the post 52 is supported on the screw head 23, as is visible in the partly sectional view in FIG. 10. Because of this structure, the connecting part 30′ can be fixed to the outer shell 14 spaced above the thermal insulation layer 13. The post 52 which is attached over the fastening element 20′, above the stop 51, is in this case part of the force transmission element 50 which may be mounted on the connecting element 33 in FIGS. 1 and 2 and, in the same manner, serves as an intermediate member between the device 11 or 11′ and equipment parts. The equipment parts (not illustrated) may be fastened to a screw-on plate 55 which is fastened to the post 52 by a height-adjustable element 53.

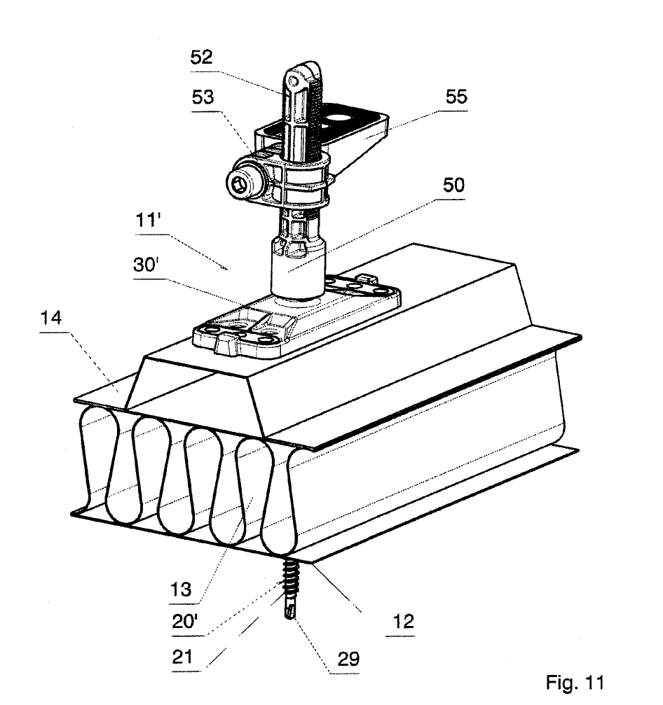

In the arrangement according to FIGS. 9-11, an outer shell 14 is arranged spaced above the thermal insulation layer 13. With the aid of the fastening elements 20, the connecting part 30′ is fastened to the outer shell 14, which in this case is presented as an element having a trapezoidal profile. The fastening elements 20 are indicated as screws in FIGS. 9 and 10.

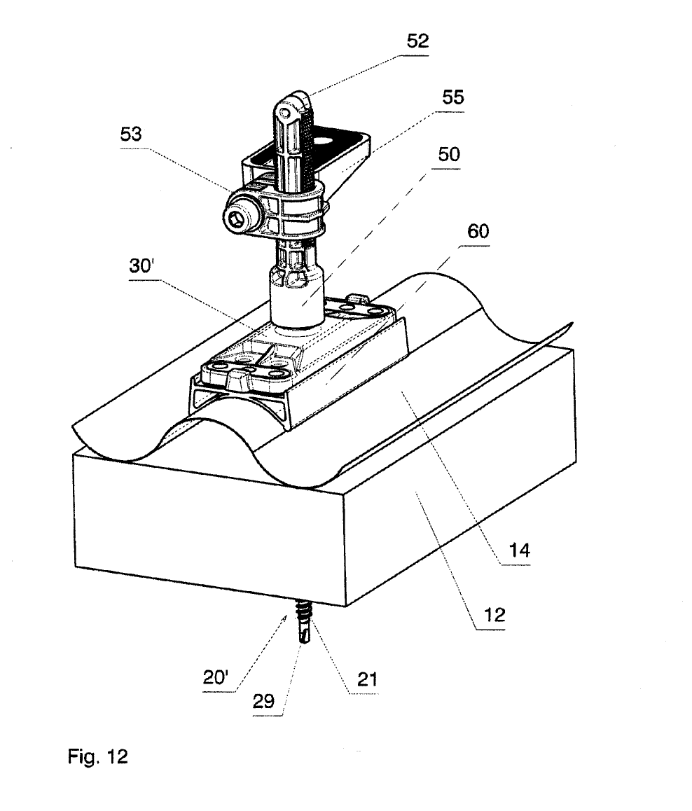

In the construction according to FIG. 12, the bolt-shaped fastening element 20′ is still present, but it may be omitted, since in this case a corrugated element forming the outer shell 14 lies directly on the load-bearing part 12, which may be the furring structure of a roof or façcade. Thus, FIG. 12 corresponds to the use of the fastening device 11′ with a single-shell building envelope. The connecting part 30′ is fastened to the corrugated element by way of an intermediate screw-on plate 60.

### LIST OF REFERENCE NUMERALS

11, 11′ Fastening device
12 Load-bearing part (furring structure)
13 Thermal insulation layer
14 Outer shell
20, 20′ Fastening element
21 Anchoring thread
22 Support thread
23 Screw head
24 Shaft
25 Thread-free portion of shaft
26 Sealing disk
29 Drilling part
30, 30′ Connecting part
31 Edge region
32 Opening
33, 33′ Connecting element
34 Connecting thread
35 Central region
36 Opening (central bore)
37 Bearing surface
38 Plate
39 Locking nut
40 Panel inset part
42 Male thread
50 Force transmission element
51 Stop
52 Post
53 Height-adjustable element
55 Screw-on plate
60 Screw-on plate
D Thickness
W Angle

1. A fastening arrangement for fastening equipment parts to a building with a sandwich or single-shell building envelope, comprising a plurality of bolt-shaped fastening elements (20, 20′) which are guided at least through a connecting part (30, 30′) to be supported on a load-bearing part (12) of the building or building envelope, the fastening elements (20, 20′) are guided through an outer shell (14) and supported on at least one of the load-bearing part (12) or the outer shell (14), wherein each of the fastening elements (20, 20′) is brought form-fittingly into engagement with the connecting part (30, 30′) or the outer shell (14), in each case so that the connecting part (30, 30′) is supported on at least one of the load-bearing part (12) or the outer shell (14).

2. The arrangement as claimed in claim 1, wherein the connecting part (30, 30′) is a panel which has, for at least each of the fastening elements (20, 20′), an opening (32, 36).

3. The arrangement as claimed in claim 1, wherein each of the fastening elements (20, 20′) is a self-drilling and self-tapping or self-forming screw having an anchoring thread (21) and a drilling part (29) for engaging in the load-bearing part (12).

4. The arrangement as claimed in claim 3, wherein each of the fastening elements (20) is provided, in a portion away from the drilling part, with a support thread (22).

5. The arrangement as claimed in claim 2, further comprising a sleeve-shaped connecting element (33) which is provided with a connecting thread (34) is inserted into one of the openings (32, 36).

6. The arrangement as claimed in claim 5, wherein the connecting element (33) is provided with a plate (38) for fixing in the connecting part (30).

7. The arrangement as claimed in claim 5, wherein the connecting element (32) is arranged in a central region (35) of the connecting part (30).

8. The arrangement as claimed in claim 5, wherein at least one of the fastening elements (20′) may be fixed form-fittingly in the connecting element (33).

9. The arrangement as claimed in claim 5, wherein at least one force transmission element (50) is mounted on the connecting element (33), as an intermediate member for connection to one of the equipment parts.

10. The arrangement as claimed in claim 1, wherein the connecting part (30) is angled in an edge region (31) in a direction away from the load-bearing part (12).

11. The arrangement as claimed in claim 1, wherein the or each of the openings (32) in the unmounted connecting part (30′) is a blind hole or a position of the openings is marked out in advance on the connecting part (30′) as a pattern of bores.

12. The device as claimed in claim 1, further comprising a sealing disk (26) located between a head of the or each of the fastening elements (20) and the connecting part (30).
